(19) United States
(12) Patent Application Publication
(10) Pub. No.: US 2004/0110857 A1
(43) Pub. Date: Jun. 10, 2004

(54) Photo-curable resin composition containing cyclic acetal compound and cured product

(75) Inventor: Hiroyuki Kanai, Shizuoka (JP)

Correspondence Address: NIXON & VANDERHYE, PC, 1100 N GLEBE ROAD, 8TH FLOOR, ARLINGTON, VA, 22201-4714, US

(73) Assignee: Polyplastics Co., Ltd., Tokyo (JP)

(21) Appl. No.: 10/613,746

(22) Filed: Jul. 7, 2003

(30) Foreign Application Priority Data
Jul. 8, 2002 (JP) 2002-198871

(51) Int. Cl. C08F 2/46

(52) U.S. Cl. 522/100

(57) ABSTRACT

The present invention provides a photo-curable resin composition composed of (A) a cyclic acetal compound, (B) an epoxy compound, and (C) a photocationic polymerization initiator, which has a low viscosity and which can be completely cured into the inside thereof in a short period of irradiation time.

### TECHNICAL FIELD

The present invention relates to a photo-curable resin composition that contains a cyclic acetal compound, an epoxy compound and a photocationic polymerization initiator and is liquid at room temperature and to a photo-cured product therefrom.

### BACKGROUND ART

A photo-curable resin is a liquid substance, which is capable of curing rapidly and selectively upon irradiation of light to form a shape. The photo-curable resin is used widely in industry such as various coatings, coating compositions, ink, adhesives, printing plates, photoresists, rapid prototyping by photoimaging, or the like, making the best of its characteristics.

Photo-curable resin compositions are roughly grouped into two types. One is of a photo-radical polymerizable type that generates radicals upon irradiation of light and polymerization and curing start therewith, and the other is of a photocation polymerizable type that generates cations upon irradiation of light and polymerization and curing start therewith.

The photocation polymerizable composition has advantages in that (1°) the composition has no polymerization inhibition by oxygen to give satisfactory surface curability; (2°) the composition has a reduced volume contraction at the time of curing; (3°) the composition has satisfactory adhesion to various substrates; (4°) its polymerization reaction proceeds after the irradiation of light; and so forth.

The photocation polymerizable composition is composed mainly of a cation polymerizable compound and a photocation initiator. As the cation polymerizable compound, mainly an epoxy compound is used.

On the other hand, a cyclic acetal compound is one of representative examples of compounds that undergo cation polymerization. For example, a product of heat cation polymerization between 1,3,5-trioxane as a main monomer and 1,3-dioxolane or the like as a copolymerization component using a Lewis acid or the like is known as an acetal resin. However, none has been known that actually contains a cyclic acetal compound as a copolymerization component of a photocation polymerizable resin composition.

For example, JP 1-213304 A discloses a resin composition for photochemical molding that contains: a cation polymerizable organic substance curable with energy rays containing at least 50 wt % of a alicyclic epoxy resin having a cyclohexene oxide structure; and an energy rays-sensitive cation polymerization initiator. Although JP 1-213304 A describes that the cation polymerizable organic substance includes epoxy compounds, cyclic ether compounds, acrylic lactone compounds, cyclic acetal compounds, cyclic thioether compounds, spiro-ortho ester compounds, and vinyl compounds, the examples therein exemplify only the epoxy compounds.

Further, JP 10-168165 discloses a composition that contains: a compound having an oxetane ring; a compound having an epoxy group; and a cationic photopolymerization initiator. The publication describes that cyclic acetals can be used additionally. However, there is no example therein that uses a cyclic acetal compound.

An object of the present invention is to obtain a photo-curable resin composition that has a low viscosity and can be completely cured into the inside thereof in a short period of irradiation time and a cured product therefrom.

### SUMMARY OF THE INVENTION

The inventors of the present invention have made extensive studies in order to achieve the above-mentioned object. As a result, they have found that photo-curing of a photo-curable resin composition composed of a cyclic acetal compound such as trioxane, an alicyclic or the like epoxy compound, and a photocationic polymerization initiator could achieve the object, thereby accomplishing the present invention.

Therefore, according to a first aspect of the present invention, there is provided a photo-curable resin composition containing (A) a cyclic acetal compound, (B) an epoxy compound, and (C) a photocationic polymerization initiator.

According to a second aspect of the present invention, there is provided a photo-curable resin composition as described in the first aspect of the invention, composed of (A) 5 to 80 wt % of a cyclic acetal compound, (B) 94.9 to 20 wt % of an epoxy compound, and (C) 0.1 to 10 wt % of a photocationic polymerization initiator (provided that total of the components (A), (B), and (C) is 100 wt %).

According to a third aspect of the present invention, there is provided a photo-curable resin composition as described in the first aspect of the invention, composed of (A) 10 to 40 wt % of a cyclic acetal compound, (B) 89.8 to 60 wt % of an epoxy compound, and (C) a photocationic polymerization initiator in a range of 0.2 to 6 wt % (provided that total of the components (A), (B), and (C) is 100 wt %).

According to a fourth aspect of the present invention, there is provided a photo-curable resin composition as described in any one of the first to third aspects of the invention, in which the cyclic acetal compound (A) is at least one kind selected from the group consisting of: trioxane; 1,3-dioxolane; 1,3-dioxane; 1,4-butanediol formal; and diethylene glycol formal.

According to a fifth aspect of the present invention, there is provided a photo-curable resin composition as described in any one of the first to fourth aspects of the invention, in which the epoxy compound (B) is (i) an epoxy cyclohexyl group-containing compound and/or (ii) a glycidyl group-containing compound.

According to a sixth aspect of the present invention, there is provided a photo-curable resin composition as described in the fifth aspect of the invention, in which the epoxy compound (B) further contains an epoxy polymer compound having a number average molecular weight of 1,000 to 20,000 in terms of polystyrene as measured by GPC.

According to a seventh aspect of the present invention, there is provided a photo-curable resin composition as described in any one of the first to sixth aspects of the invention, in which the photocationic polymerization initiator (C) is an aromatic onium salt.

According to an eighth aspect of the present invention, there is provided a photo-curable resin composition as described in the seventh aspect of the invention, in which the aromatic onium salt is a triarylsulfonium salt.

According to a ninth aspect of the present invention, there is provided a photo-curable resin composition as described in any one of the first to eighth aspects of the invention, further containing (d) a polyol having 2 or more hydroxyl groups in one molecule besides the components (A), (B), and (C).

According to a tenth aspect of the present invention, there is provided a photo-curable resin composition as described in he ninth aspect of the invention, in which the polyol (d) is a polyol having 2 to 6 hydroxyl groups in one molecule.

According to an eleventh aspect of the present invention, there is provided a photo-curable resin composition as described in any one of the first to tenth aspects of the invention, further containing an ethylenically unsaturated monomer (e) and a photo-radical polymerization initiator (f) besides the components (A), (B), and (C).

According to a twelfth aspect of the present invention, there is provided a photo-curable resin composition as described in any one of the first to eleventh aspects of the invention, further containing a photosensitizer (g) besides the components (A) , (B), and (C).

According to a thirteenth aspect of the present invention, there is provided a photo-curable resin composition as described in any one of the first to twelfth aspects of the invention, having a viscosity (25° C.) of 50 to 2,000 mPa·s.

According to a fourteenth aspect of the present invention, there is provided a cured product obtained by photo-curing a photo-curable resin composition as described in any one of the first to thirteenth aspects of the invention.

### DETAILED DESCRIPTION OF THE PREFERRED EMBODIMENT

Hereinafter, the present invention will be described in detail.

(A) Cyclic Acetal Compound

The cyclic acetal compound (A) used in the present invention (hereinafter, also referred to as “component (A)”) is a compound represented by the following general formula (1)

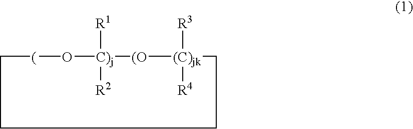

(wherein R¹, R², R³, and R⁴represent a hydrogen atom or a hydrocarbon group having 8 or less carbon atoms, which may be the same or different; i is an integer of 1 or more; j is an integer of 2 or more; and k is an integer of 0 or more).

Examples of the cyclic acetal compound include trioxane, tetratrioxane, 1,3-dioxolane, 1,3,5-trioxepane, 1,3-dioxane, ethylene glycol formal, propylene glycol formal, diethylene glycol formal, triethylene glycol formal, 1,4-butanediol formal, 1,5-pentanediol formal, and 1,6-hexanediol formal.

In particular, trioxane, 1,3-dioxolane, 1,3-dioxane, 1,4-butanediol formal, and diethylene glycol formal are preferable because of their industrial availability.

The content of the component (A) in the resin composition of the present invention is 5 to 80 wt %, preferably 10 to 60 wt %, and more preferably 1 to 40 wt % based on the total 100 wt % of the components (A), (B) and (C).

(B) Epoxy Compound

“Epoxy compound (B)” (hereinafter, also referred to as “component (B)”) refers to a compound having an ethylene oxide structure of a 3-membered ring. The epoxy compound has one or more ethylene oxide structure, preferably 2 to 15 ethylene oxide structures, and more preferably 2 to 8 ethylene oxide structures in the molecule.

The epoxy compound (B) includes (i) an epoxycyclohexyl group-containing compound and/or (ii) a glycidyl group-containing compound and optionally (iii) an epoxy polymer compound having a number average molecular weight of 1,000 to 20,000 in terms of polystyrene as measured by GPC.

A preferred epoxy compound (B) includes (i) a compound having an epoxycyclohexyl group in the molecule (epoxycyclohexyl group-containing compound) and (ii) a compound having a glycidyl group in the molecule (glycidyl group-containing compound). The epoxycyclohexyl group-containing compound has excellent cation polymerizability. On the other hand, the glycidyl group-containing compound can impart the polymer with flexibility, thereby increasing the mobility of a polymerization system and further increasing the curability thereof.

(i) Epoxycyclohexyl Group-Containing Compound

Specific examples of the epoxycyclohexyl group-containing compound (i) include

3,4-epoxycyclohexylmethyl-3′,4′-epoxycyclohexanecarboxylate,

2-(3,4-epoxycyclohexyl-5,5-spiro-3,4-epoxy)cyclohexane-meta-di oxane, bis(3,4-epoxycyclohexylmethyl)adipate,

bis(3,4-epoxy-6-methylcyclohexylmethyl)adipate,

3,4-epoxy-6-methylcyclohexyl-3′,

4′-epoxy-6′-methylcyclohexanecarboxylate, methylenebis(3,4-epoxycyclohexane),

di(3,4-epoxycyclohexylmethyl)ether of ethylene glycol,

ethylenebis(3,4-epoxycyclohexanecarboxylate), ε-caprolactone modified

3,4-epoxycyclohexylmethyl-3′,4′-epoxycyclohexanecarboxylate, trimethylcaprolactone modified

3,4-epoxycyclohexylmethyl-3′,4′-epoxycyclohexanecarboxylate, and β-methyl-δ-valerolactone modified

3,4-epoxycyclohexylmethyl-3′,4′-epoxycyclohexanecarboxylate.

Of those,

3,4-epoxycyclohexylmethyl-3′,4′-epoxycyclohexanecarboxylate, bis(3,4-epoxycyclohexylmethyl)adipate, ε-caprolactone modified

3,4-epoxycyclohexylmethyl-3′,4′-epoxycyclohexanecarboxylate, trimethylcaprolactone modified

3,4-epoxycyclohexylmethyl-3′,4′-epoxycyclohexanecarboxylate, and β-methyl-δ-valerolactone modified

3,4-epoxycyclohexylmethyl-3′,4′-epoxycyclohexanecarboxylate are preferable, and

3,4-epoxycyclohexylmethyl-3′,4′-epoxycyclohexanecarboxylate, and bis(3,4-epoxycyclohexylmethyl)adipate are particularly preferable.

Examples of the commercially available epoxycyclohexyl group-containing compound (i) include: UVR-6100, UVR-6105, UVR-6110, UVR-6128, UVR-6200, and UVR-6216 (produced by Union Carbide Corporation); celloxide 2021, celloxide 2021 P, celloxide 2081, celloxide 2083, celloxide 2085, epolead GT-300, epolead GT-301, epolead GT-302, epolead GT-400, epolead 401, and epolead 403 (produced by Daicel Chemical Industries, Ltd.); and KRM-2100, KRM-2110, and KRM-2199 (produced by Asahi Denka Co., Ltd.).

(ii) Glycidyl Group-Containing Compound

Examples of the glycidyl group-containing compound (ii) include: bisphenol A diglycidyl ether; bisphenol F diglycidyl ether; bisphenol S diglycidyl ether; brominated bisphenol A diglycidyl ether; brominated bisphenol diglycidyl ether; brominated bisphenol S diglycidyl ether; hydrogenated bisphenol A diglycidyl ether; hydrogenated bisphenol F diglycidyl ether; hydrogenated bisphenol S diglycidyl ether; 1,4-butanediol diglycidyl ether; 1,6-hexanediol diglycidyl ether; glycerin triglycidyl ether; trimethylolpropane triglycidyl ether; polyethyleneglycol diglycidyl ether; polypropyleneglycol diglycidyl ethers; polyglycidyl ethers of polyether polyols obtained by adding one or two or more alkylene oxides to aliphatic polyhydric alcohols such as ethylene glircol, propylene glycol, and glycerin; diglycidyl esters of aliphatic long-chain dibasic acids; monoglycidyl ethers of aliphatic higher alcohols; phenol, cresol, butylphenol and monoglycidyl ethers of polyether alcohol obtained by adding alkylene oxides to those; and glycidyl esters of higher fatty acids.

Of those, bisphenol A diglycidyl ether, bisphenol F diglycidyl ether, hydrogenated bisphenol A diglycidyl ether, hydrogenated bisphenol F diglycidyl ether, 1,4-butanediol diglycidyl ether, 1,6-hexanediol diglycidyl ether, glycerin triglycidyl ether, trimethylolpropane triglycidyl ether, neopentylglycol diglycidyl ether, polyethyleneglycol diglycidyl ether, and polypropyleneglycol diglycidyl ether are preferable.

Examples of the commercially available glycidyl group-containing compound (ii) include: UVR-6216 (produced by Union Carbide Corporation), Glycidol, AOEX 24, and CYCLOMER A-200 (produced by Daicel Chemical Industries, Ltd.); Epikote 825, Epikote 826, Epikote 827, Epikote 828, Epikote 806, Epikote 807, Epikote 152, Epikote 154, Epikote 871, and Epikote 872 (produced by Japan Epoxy Resins Co., Ltd.); and KRM-2400, KRM-2410, KRM-2408, KRM-2490, KRM-2720, and KRM-2750 (produced by Asahi Denka Co., Ltd.).

(iii) Epoxy Polymer Compound

Further, besides the above-mentioned components (i) and (ii), it is possible to add (iii) an epoxy polymer compound having a number average molecular weight of 1,000 to 20,000 in terms of polystyrene as measured by GPC as the epoxy compound that constitutes the component (B). This can improve toughness of a cured product of the photo-curable resin composition of the present invention.

Such an epoxy polymer compound (iii) includes: (1) an epoxy-modified compound obtained by a method of epoxidation of a carbon-to-carbon double bond of a corresponding compound having an ethylenically unsaturated bonding group with a suitable oxidizing agent such as hydrogen peroxide or a peracid; (2) an epoxy group-containing polymer obtained by polymerizing a radical polymerizable monomer containing an epoxy group in the molecule; and (3) an epoxy group-containing compound obtained by a production method known per se such as a method in which a compound having a functional group such as a hydroxyl group is reacted with epichlorohydrin.

To obtain the epoxy polymer compound (iii) having a number average molecular weight of 1,000 to 20,000 in terms of polystyrene, in the case of the epoxy-modified compound (1) described above, it is only needed to use a compound having a number average molecular weight of 1,000 or more and less than 20,000 in terms of polystyrene as the compound having an ethylenically unsaturated bonding group as a raw material. In the case of the epoxy group-containing polymer (2) described above, it is only needed to make adjustment by a known method such that a polymer having a desired degree of polymerization can be obtained. In the case of the epoxy group-containing compound (3) described above, it is only needed to use a compound having a number average molecular weight of 1,000 or more and less than 20,000 in terms of polystyrene as the compound having a functional group such as a hydroxyl group as a raw material. Commercially available products of the epoxy-modified compound (1) described above includes Polyb d R-45EPI (manufactured by Idemitsu Petro-Chemical Co., Ltd), R-l5EPI and R-45EPI (both manufactured by Nagase Chemical Industries, Co., Ltd.), and Epolead PB3600 and PB4700 (both manufactured by Daicel Chemical Industries, Co., Ltd.).

The content of the component (B) in the resin composition of the present invention is 94.9 to 20 wt %, preferably 90 to 40 wt %, and more preferably 89.8 to 60 wt % based on total 100 wt % of the components (A), (B) and (C).

In the epoxy compound (B), the epoxycyclohexyl group-containing compound (i) is a main component and the contents of the glycidyl group-containing compound (ii) and the epoxy polymer compound (iii) are preferably less than that of the epoxycyclohexyl group-containing compound (i).

(C) Photocationic Polymerization Initiator

The photocationic polymerization initiator (C) (hereinafter, also referred to as “component (C)”) is a compound that can release a substance that starts cation polymerization of the component (A) with the component (B) by receiving energy rays such as light and electron beams. Here, the energy rays such as light and electron beam include visible light, ultra violet-rays, infrared rays, X-rays, y-rays, G-rays or electron beams. In the present invention, even in the case where the initiator receives electron beams, the initiator is called a photocationic polymerization initiator.

A suitable compound that constitutes the component (C) includes an onium salt having a structure represented by the following formula (2). The onium salt is a compound that releases a Lewis acid by receiving light.

[R⁵ₐR⁶_{b}R⁷_{c}R⁸_{d}Z]^{+m}[MXₙ₊ₘ]^{-m} (2)

[wherein cation is an onium ion, Z represents S, Se, Te, P, As, Sb, Bi, O, I, Br, Cl or N≡N; R⁵, R⁶, R⁷ and R⁸ represent organic groups which may be the same or different; a, b, c and d are each integers of 0 to 3, provided that (a+b+c+d) is equal to a valence of Z; M represents a metal or metalloid that constitutes a center atom of a halide complex [MXₙ₊ₘ], such as B, P, As, Sb, Fe, Sn, Bi, Al, Ca, In, Ti, Zn, Sc, V, Cr, Mn, and Co; X represents a halogen atom such as F, Cl, or Br; m is a net charge of a halide complex ion; and n is a valence of M.]

In the above formula (2), specific examples of the onium ion include diphenyliodonium, 4-methoxydiphenyliodonium,

bis(4-methylphenyl)iodonium, bis(4-tert-butylphenly)iodonium,

bis(dodecylphenyl)iodonium, triphenylsulfonium,

diphenyl-4-thiophenoxyphenylsulfonium,

bis[4-(diphenylsulfonio)-phenyl]sulfide,

bis[4-(di(4-(2-hydroxyethyl)phenyl)sulfonio)-phenyl]sulfide, and

η⁵-2,4-(cyclopentadienyl)[1,2,3,4,5,6-η]-(mehtylethyl)-benzene-iron(1+).

In the above formula (2), specific examples of the anion [MXₙ₊ₘ] include tetrafluoroborate (BF₄⁻), hexafluorophosphate (PF₆⁻), hexafluoroantimonate (SbF₆⁻), hexafluoroarsenate (AsF₆⁻), and hexachloroantimonate (SbCl₆⁻).

Also, onium salts containing anions represented by the general formula [Mxn(OH)⁻] showing anion may be used. Further, onium salts containing other anions such as per chlorate ion (CIO₄⁻), trifluoromethanesulfonic acid ion (CF₃SO₃⁻), fluorosulfonic acid ion (FSO₃⁻), toluenesulfonicacidion, trinitrobenzenesulfonicacid ion and trinitrotoluenesulfonic acid ion may also be used.

Of those onium salts, an aromatic onium salt is particularly preferable as the photocationic polymerization initiator for the component (C). For example, preferable are aromatic halonium salts as described in JP50-151996A, JP50-158680A, etc; VIA group aromatic onium salts as described in JP 50-151997 A, JP 52-30899 A, JP 56-55420 A, JP 55-125105 A, etc; VA group aromatic onium salts as described in JP 50-158698 A, etc; oxosulfoxonium salts as described in JP 56-8428 A, JP 56-149402 A, JP 57-192429 A, etc; aromatic diazonium salts as described in JP 49-17040 A; and thiopyrylium salts as described in U.S. Pat. No. 4,139,655. Further, iron, allele complex, aluminum complex/photo decomposing silicon compound type initiators, etc. may also be given.

Examples of the commercially available photocationic polymerization initiator suitably applicable to the component (C) include: UVI-6950, UVI-6970, UVI-6974, and UVI-6990 (produced by Union Carbide Corporation); Uva curel 590, and Uva curel 591 (produced by Daicel-UCB Co., Ltd.); Adeka Optomer SP-150, SP-151, SP-170, and SP-172 (produced by Asahi Denka Co., Ltd.); Irgacure261 (produced by Ciba Specialty Chemicals K. K.); CI-2481, CI-2624, CI-2639, CI-2064, and CI-5102 (produced by Nippon Soda Co., Ltd.); CD-1010, CD-1011, and CD-1012 (produced by Sartomer Company, Inc.); DTS-102, DTS-103, NAT-103, NDS-103, TPS-103, MDS-103, MPI-10S, and BBI-103 (produced by Midori Kagaku Co., Ltd.); and PCI-061T, PCI-062T, PCI-020T, and PCI-022T (produced by Nippon Kayaku Co., Ltd.).

The above-mentioned photocationic polymerization initiator may constitute the component (C) singly or as combinations of two or more of them.

The content of the component (C) in the resin composition of the present invention is 0.1 to 10 wt %, preferably 0.2 to 6 wt %, and more preferably 0.5 to 4 wt % based on total 100 wt % of the components (A), (B) and (C) . In the case where the content of the component (C) is too small, there arise defects in that the photocurability of the obtained resin composition is decreased, the curing time is too long, and unreacted components (A) and (B) remain, which is undesirable. On the other hand, in the case where the-content of the component (C) is too large, it becomes difficult to control curing so that a cured product has a decreased physical property, which is undesirable.

(D) Other Components

The photo-curable resin composition of the present invention may contain other components (D) other than the above-mentioned components (A), (B), and (C) if necessary so far as the effects of the present invention are not damaged.

The other components (D) include the following polyol (d), ethylenically unsaturated monomer (e) and photo-radical polymerization initiator (f) for polymerizing them, photosensitizer (polymerization accelerator) (g), reactive diluent (h), and various additives.

Based on total 100 parts by weight of the components (A), (B) and (C), the polyol (d) is 30 parts by weight or less, the ethylenically unsaturated monomer (e) is 40 parts by weight or less, the photo-radical polymerization initiator (f) is 5 parts by weight or less, and the photosensitizer (g) is 5 parts by weight or less.

Polyol (d)

The photo-curable resin composition may contain a polyol in order to increase the curing speed of the resin composition and to exhibit shape stability of a cured product (ability of preventing time-dependent deformation) and physical property stability (ability of preventing time-dependent change in mechanical characteristics).

The polyol (d) used has preferably two or more hydroxyl groups in one molecule and more preferably 2 to 6 hydroxyl groups in one molecule. When a polyol having less than 2 hydroxyl groups in one molecule is used, the effect of improving photo-curability tends to be insufficient, and the mechanical characteristics, particularly elastic modulus, of the obtained cured product tend to be decreased. On the other hand, when a polyol having more than 6 hydroxyl groups in one molecule is contained, a tendency that the obtained cured product has a decreased elongation is observed and at the same time there tends to arise a problem in its resistance to humidity.

Such polyols (d) include polyether polyol, polycaprolactone polyol, and polyester polyol obtained by modifying polyester made from dibasic acid and diol.

Of the above polyols (d), polyether polyol is preferable. For example, polyether polyols can be exemplified which are obtained by modifying polyalcohols with 3 or more hydroxyl groups such as trimethylolpropane, glycerin, pentaerythrytol, sorbitol, sucrose, and quadrol, with cylic ether compounds such as ethylene oxide (EO), propylene oxide (PO), butylene oxide, and tetrahydrofuran. Specifically, EO modified trimethylolpropane, PO modified trimethylolpropane, tetrahydrofuran modified trimethylolpropane, EO modified glycerin, PO modified glycerin, tetrahydrofuran modified glycerin, EO modified pentaerythrytol, PO modified pentaerythrycol, tetrahydrofuran modified pentaerythrytol, EO modified sorbitol, PO modified sorbitol, EO modified sucrose, PO modified sucrose, EO modified sucrose, EO modified quadrol, polyoxyethylenediol, polyoxypropylenediol, polyoxytetramethylenediol, polyoxybutylenediol, and polyoxybutylene/oxyethylene copolymer diol can be exexmplified. Of those, EO modified trimethylolpropane, PO modified trimethylolpropane, PO modified glycerin and PO modified sorbitol are preferable.

Examples of applicable and commercially available polyether polyols include: SANNIX TP-400, SANNIX GP-600, SANNIX GP-1000, SANNIX SP-750, SANNIX GP-250, SANNIX GP-400, and SANNIX GP-600 (produced by Sanyo Chemical Industries, Ltd.); TMP-3Glycol, PNT-4Glycol, EDA-P-4, and EDA-P-8 (produced by Nippon Nyukazai Co., Ltd.); and G-300, G-400, G-700, T-400, EDP-450, SP-600, and SC-800 (produced by Asahi Denka Co., Ltd.).

Specific examples of the polycaprolactone polyol include caprolactone modified trimethylolpropane, caprolactone modified glycerin, caprolactone modified pentaerythrytol, and caprolactone modified sorbitol.

Examples of the commercially available polycaprolactone polyol include TONE0301, TONE0305, and TONE0310 (produced by Union Carbide Corporation). Commercially available polyester polyol includes PLACCEL 303, PLACCEL 305, and PLACCEL 308 (produced by Daicel Chemical Industries, Ltd.).

The above-mentioned polyols (d) may be used singly or in combination of two or more of them.

The number average molecular weight of the polyol (d) used is preferably 100 to 50,000 and more preferably 160 to 20,000. Use of a polyol having too small a molecular weight makes it in some cases difficult to obtain shape stability and physical property stability of a cured product. On the other hand, use of a polyol having too large a molecular weight makes the viscosity of the obtained resin composition too high so that its handling may become difficult. Ethylenically unsaturated monomer (e)

The resin composition of the present invention may use in combination an ethylenically unsaturated monomer (e), which is a radical polymerizable compound, in order to increase the mechanical strength of a cured product or to shorten the curing time. The ethylenically unsaturated monomer (e) is a compound that has an ethylenically unsaturated bond (C═C) in the molecule and examples thereof include a monofunctional monomer that has one ethylenically unsaturated bond in one molecule and a polyfunctional monomer having two or more ethylenically unsaturated bonds in one molecule.

Examples of the monofunctional monomer that has one ethylenically unsaturated bond group in one molecule include

acrylamide, (meth)acryloylmorpholine,

7-amino-3,7-dimethyloctyl (meth) acrylate,

isobutoxymethyl (meth) acrylamide,

isobornyloxyethyl (meth) acrylate, isobornyl (meth) acrylate,

2-ethylhexyl (meth) acrylate, ethyl diethylene glycol (meth) acrylate,

t-octyl(meth) acrylamide, diacetone (meth) acrylamide,

dimethylaminoethyl (meth) acrylate,

diethylaminoethyl (meth) acrylate, lauryl (meth) acrylate,

dicyclopentadiene (meth) acrylate,

dicyclopentenyloxyethyl (meth) acrylate,

dicyclopentel (meth) acrylate, N,N-dimethyl (meth) acrylamide

tetrachlorophenyl (meth) acrylate,

2-tetrachlorophenoxyethyl (meth) acrylate,

tetrahydrofurfuryl (meth) acrylate,

tetrabromophenyl (meth) acrylate,

2-tetrabromophenoxyethyl (meth) acrylate,

2-trichlorophenoxyethyl (meth) acrylate,

tribromophenyl (meth) acrylate,

2-tribromophenoxyethyl (meth) acrylate,

2-hydroxyethyl (meth) acrylate, 2-hydroxypropyl (meth) acylate,

vinylcaprolactam, N-vinylpyrrolidone, phenoxyethyl (meth) acrylate,

butoxyethyl (meth) acrylate, pentachlorophenyl (meth) acrylate,

pentabromophenyl (meth) acrylate, polyethylene

glycolmono (meth) acrylate, polypropylene glycolmono (meth) acrylate, bornyl (meth) acrylate, methyl triethylene diglycol (meth) acrylate and, the compounds represented by the following formulas (3) to (5). Those monofunctional monomers may be used alone or in combination of two or more.

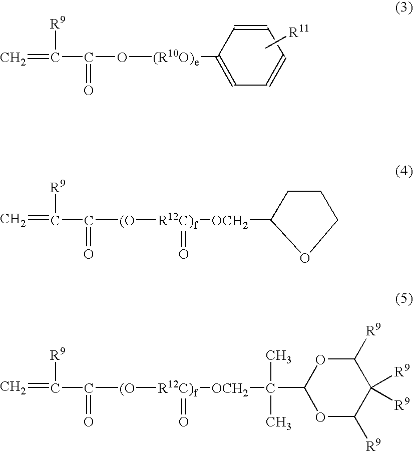

[In the formulas (3) to (5), R⁹ represents a hydrogen atom or a methyl group, R¹⁰ represents an alkylene group having 2 to 6, preferably 2 to 4 carbon atoms, R¹¹ represents a hydrogen atom, or an alkyl group having 1 to 12, preferably 1 to 9 carbon atoms, R¹² represents an alkylene group having 2 to 8, preferably 2 to 5 carbon atoms, e is an integer of 0 to 12, preferably 1 to 8, and f is an integer of 1 to 8, preferably 1 to 4.]

Of those monofunctional monomers, isobornyl (meth) acrylate, lauryl (meth) acrylate, and phenoxyethyl (meth) acrylate are preferable but the present invention is not limited thereto.

Examples of those commercially available monofunctional monomers include: AronixM-101, M-102, M-111, M-113, M-117, M-152, andTO-1210 (ToagoseiCo., Ltd.); KayaradTC-110S, R-564, and R-128H (Nippon Kayaku Co., Ltd.); and Viscoat 192, Viscoat 220, Viscoat 2311HP, Viscoat 2000, Viscoat 2100, Viscoat 2150, Viscoat 8F, and Viscoat 17F (Osaka Organic Chemical Industry Ltd.).

Examples of the polyfunctional monomer having two or more ethylenically unsaturated bond group in one molecule include

ethylene glycol di (meth) acrylate, dicyclopentenyl

di (meth) acrylate, triethylene glycol diacrylate, tetraethylene

glycol di (meth) acrylate, tricyclodecanediyldimethylene

di (meth) acrylate, tris(2-hydroxyethyl)isocyanurate

di (meth) acrylate, tris(2-hydroxyethyl)isocyanurate

tri (meth) acrylate, caprolactone modified

tris(2-hydroxyethyl)isocyanurate tri (meth) acrylate,

trimethylolpropane tri (meth) acrylate, EO modified

trimethylolpropane tri (meth) acrylate, PO modified

trimethylolpropane tri (meth) acrylate, tripropylene glycol

di (meth) acrylate, neopentyl glycol di (meth) acrylate,

(meth) acrylic acid adducts of bisphenol A diglycidyl ether at both ends, 1,4-butanediol di (meth) acrylate, 1,6-hexanediol

di (meth) acrylate, pentaerythrytol tri (meth) acrylate,

pentaerythrytol tetra (meth) acrylate, polyester di (meth) acrylate,

polyethylene glycol di (meth) acrylate, dipentaerythrytol

hexa (meth) acrylate, dipentaerythrytol penta (meth) acrylate,

dipentaerythrytol tetra (meth) acrylate, caprolactone modified

dipentaerythrytol hexa (meth) acrylate, caprolactone modified

dipentaerythrytol penta (meth) acrylate, ditrimethylolpropane

tetra (meth) acrylate, EO modified bisphenol A di (meth) acrylate, PO modified bisphenol A di (meth) acrylate, EO modified hydrogenated bisphenol A di (meth) acrylate, PO modified hydrogenated bisphenol A di (meth) acrylate, EO modified bisphenol F di (meth) acrylate, and (meth) acrylate of phenolnovolac polyglycidyl ether. Those polyfunctional monomers may be used alone or in combination of two or more.

Of those polyfunctional monomers, trimethylolpropane

tri (meth) acrylate, EO modified trimethylolpropane

tri (meth) acrylate, PO modified trimethylolpropane

tri (meth) acrylate, pentaerythrytol tri (meth) acrylate,

pentaerythrytol tetra (meth) acrylate, dipentaerythrytol

hexa (meth) acrylate, dipentaerythrytol penta (meth) acrylate,

dipentaerythrytol tetra (meth) acrylate, caprolactone modified

dipentaerythrytol hexa (meth) acrylate, caprolactone modified

dipentaerythrytol penta (meth) acrylate, and ditrimethylolpropane

tetra (meth) acrylate are preferable but the present invention is not limited thereto.

Examples of those commercially available polyfunctionaL monomers include: SA1002 (Mitsubishi Chemical Corporation); Viscoat 195, Viscoat 230, Viscoat 260, Viscoat 215, Viscoat 310, Viscoat 214HP, Viscoat 295, Viscoat 300, Viscoat 360, Viscoat GPT, Viscoat 400, Viscoat500, Viscoat540, Viscoat3000, and Viscoat3700 (Osaka Organic Chemical Industry Ltd.); Kayarad R-526, HDDA, NPGDA, TPGDA, MANDA, R-551, R-712, R-604, R-684, PET-30, GPO-303, TMPTA, THE-330, DPHA, DPHA-2H, DPHA-2C, DPHA-2I, D-310, D-330, DPCA-20, DPCA-30, DPCA-60, DPCA-120, DN-0075, DN-2475, T-1420, T-2020, T-2040, TPA-320, TPA-330, RP-1040, RP-2040, R-011, R-300, and R-205 (Nippon Kayaku Co., Ltd.); Aronix M-210, M-220, M-233, M-240, M-215, M-305, M-309, M-310, M-315, M-325, M-400, M-6200, and M-6400 (ToagoseiCo., Ltd.); light-acrylate BP-4EA, BP-4PA, BP-2EA, BP-2PA, and DCP-A (Kyoeisha Chemical Co., Ltd.); New Frontier BPE-4, TEICA, BR-42M, and GX-8345 (Dai-ichi Kogyo Seiyaku Co., Ltd.); ASF-400 (Nippon Steel Chemical Group); Lipoxy SP-1506, SP-1507, SP-1509, VR-77, SP-4010, and SP-4060 (Showa Highpolymer Co., Ltd.); and N K Ester A-BPE-4(Shin-Nakamura Chemical Co., Ltd.).

Such polyfunctional monomers are preferably, tri (meth) acrylate compounds, tetra (meth) acrylate compounds, penta (meth) acrylate compounds, and hexa (meth) acrylate compounds shown above. Of those, trimethylolpropane tri (meth) acrylate, EO modified trimethylolpropane tri (meth) acrylate, dipentaerythrytol hexa (meth) acrylate, dipentaerythrytol penta (meth) acrylate, and ditrimethylolpropane tetra (meth) acrylate are particularly preferable but the present invention is not limited thereto. Photo-radical polymerization initiator (f)

In the case where the resin composition contains the ethylenically unsaturated monomer (e), in order to initiate its radical polymerization reaction, usually a photo-radical polymerization initiator (f) is added thereto. The photo-radical polymerization initiator (f) is a compound that is decomposed by receiving energy rays such as light and starts radical polymerization reaction of the ethylenically unsaturated monomer by the generated free radicals.

An ordinary photo-radical polymerization initiator maybe used as the photo-radical polymerization initiator (f). Examples thereof include acetophenone, acetophenone benzylketal, anthraquinone,

1-(4-isopropylphenyl)-2-hydroxy-2-methylpropan-l-one, carbazole,

xanthone, 4-chlorobenzophenone, 4,4′-diaminobenzophenone,

1,1-dimethoxydeoxybenzoin, 3,3′-dimethyl-4-methoxybenzophenone, thioxanthone type compounds,

2-methyl-1-[4-(methylthio)phenyl]-2-morpholino-propan-2-one,

2-benzyl-2-dimethylamino-1-(4-morpholinophenyl)-butan-1-one,

triphenylamine, 2,4,6-trimethylbenzoyldiphenylphosphine oxide,

bis(2,6-dimethoxybenzoyl)-2,4,4-tri-methylbenzylphosphine oxide,

benzyldimethylketal, 1-hydroxycyclohexyl phenyl ketone,

2-hydroxy-2-methyl-1-phenylpropane-1-one, fluorenone, fluorene,

benzaldehyde, benzoin ethyl ether, benzoin isopropyl ether,

benzophenone, Michler's ketone, 3-methylacetophenone,

3,3′,4,4′-tetra(t-butylperoxycarbonyl)benzophenone (BTTB), and

BTTB in combination with xanthene, thioxanthene, coumarin,

ketocoumarin, or other pigment sensitizers. Of those, benzyldimethylketal, 1-hydroxycyclohexyl phenyl ketone,

2,4,6-trimethylbenzoyldiphenylphosphine oxide, and

2-benzyl-2-dimethylamino-1-(4-morpholinophenyl)-butan-1-one are particularly preferable but the present invention is not limited thereto.

The photo-curable resin composition of the present invention may contain a photosensitizer (polymerization accelerator) (g), a reactive diluent (h) and so forth so far as the effects of the present invention are not damaged.

Examples of the photosensitizer (g) include: amine type compounds such as triethanolamine, methyldiethanolamine, triethylamine, and diethylamine; thioxanthone and thioxanthone derivatives; anthraquinone and anthraquinone derivatives; anthracene and anthracene derivatives; perylene and perylene derivatives; benzophenone; and benzoin isopropyl ether.

Further, as the reactive diluent (h), a cation polymerizable substance that can copolymerize with the components (A) and (B) and that decreases the viscosity of a solution of the obtained resin composition is preferable.

Various Kinds of Additives

Furthermore, the photo-curable resin composition of the present invention may contain various kinds of additives so far as the effects of the present invention are not damaged. Such additives include: polymers and oligomers such as polyamides, polyamideimides, polyurethanes, polybutadienes, polychloroprenes, polyethers, polyesters, styrene-butadiene-styrene block copolymers, petroleum resins, xylene resins, ketone resins, cellulose resins, fluorine-containing oligomers, silicone oligomers, and polysulfide oligomers; polymerization inhibitors; polymerization initiation aids; age resistors; leveling agents; wettability improvers; surfactants; plasticizers; ultraviolet absorbents; antioxidants; silane-coupling agents; inorganic filers; pigments; and dyes.

<Preparation Method for Photo-Curable Resin Composition>

The photo-curable resin composition of the present invention can be prepared by uniformly mixing the above-mentioned components (A), (B), and (C) and various kinds of optional components as necessary.

<Defoaming Treatment>

In the case where the photo-curable resin composition of the present invention is prepared, it is preferable that after each component is mixed, foreign matter be removed by filtration and further defoaming treatment be performed. Performing the defoaming treatment can prevent foams that cause a decrease in dimension stability and appearance failure from remaining in a cured product obtained from the photo-curable resin composition.

The method of defoaming treatment is not particularly limited and examples thereof include: a method of forcibly removing foams in the photo-curable resin composition by reducing pressure; and a method of heating the photo-curable resin composition to decrease the viscosity thereof and removing foams that collect on the surface of the resin composition.

<Viscosity of Photo-Curable Resin Composition>

The viscosity (25° C.) of the photo-curable resin composition of the present invention is preferably 50 to 2,000 mPa·s and more preferably 70 to 1,500 mPa·s.

<Photo-Curing Method>

The curing of the photo-curable resin composition of the present invention can be performed by a method that has already been known. For example, in the case of applications to a coating and painting, the composition of the present invention is coated on the surface of an object to be covered with a cured product and is then irradiated with light to be cured. In the case of applications to photochemical molding, a laser beam is scanned on the composition of the present invention by using a commercially available photochemical molding machine to selectively cure the composition to obtain a three-dimensional molding. In the case of applications to adhesives and sealants, it is only needed that the composition of the present invention be filled in a desired place and then be irradiated with light to be cured. In the case of applications to photoresists, it is only needed that the composition of the present invention be coated on a surface of a substrate by a method such as dipping or spin coating and be exposed to light in a desired circuit pattern and cured. In the case of applications to printing, it is only needed that ink be coated using a printer and then be irradiated with light to be cured. The photo-curing method is not limited to those.

### EXAMPLE

Hereinafter, the present invention is described more concretely by way of examples. However, the present invention should not be construed as being limited by these examples.

Note that unless otherwise indicated specifically, the composition of each component in Tables 1 to 4 is by wt %.

The raw materials used in Tables 1 to 4 are as follows.

(A) Cyclic Acetal

1,3,5-trioxane: produced by Tokyo Kasei Kogyo Co., Ltd.

1,3-dioxolane: produced by Sigma-Aldrich Co.

(B) Epoxy Resin

3,4-epoxycyclohexylmethyl 3′,4′-epoxycyclohexanecarboxylate: Celloxide 2021 (produced by Daicel Chemical Industries, Ltd.)

1,6-hexanediol diglycidyl ether (hereinafter 1,6-HD*DGE): Epolight 1600 (produced by Kyoeisha Chemical Co., Ltd.)

epoxy modified polybutadiene: Epolead PB3600 (produced by Daicel Chemical Industries, Ltd.)

(C) Photocationic Polymerization Initiator

a propylene carbonate solution containing 25% of bis-p-diphenylsulfoniumphenylsulfide hexafluorophosphate and25% of diphenylphenyl thiophenylsulfonium hexafluorophosphate: Uvacurel 591 (produced by Daicel-UCB Co., Ltd.)

naphthyl typesulfonium PF₆ salts:CI-5102 (produced by Nippon Soda Co., Ltd.)

(D) Other Components

polyol (d)

propyleneoxide modified glycerin (hereinafter PO modified glycerin): SANNIX GP-400 (produced by Sanyo Chemical Industries, Ltd.)

ethylenically unsaturated monomer (e)

trimethylolpropane triacrylate (hereinafter TMP triacrylate): Aronix M-350 (produced by Toagosei Co., Ltd.)

photo-radical polymerization initiator (f)

1-hydroxycyclohexyl phenyl ketone (hereinafter 1-OH): produced by Tokyo Kasei Kogyo Co., Ltd.

sensitizer (g)

CS-7102 (produced by Nippon Soda Co., Ltd.)

Inorganic filler

titanium dioxide: TITONESR-1 (produced by Sakai Chemical Industry Co., Ltd.)

According to the formulae shown in Tables 1 to 4, (A), (B), and (C) as well as other components were stirred and mixed to obtain compositions.

2 ml of the composition was taken in an aluminum dish having a diameter of 5 cm and was irradiated with light from a high-pressure mercury lamp (110 W/cm) for 5 minutes from a height of 20 cm to polymerize the composition. The degree of polymerization was evaluated by the degree of curing of the resin component. The indices of the degree of polymerization are defined as o in the case where all the resin components were cured and no liquid portion remained and × in the case where a liquid portion remained (for example, in the case where the surface was cured but a liquid product remained inside) . The evaluation results of degree of polymerization are also shown in Tables 1 to 4.

### Examples 1 To 10 and Comparative Example 1

In the case where only the epoxy resin was photocationically polymerized (Comparative Example 1), irradiation for 5 seconds resulted in curing only the surface but much of the liquid product remained inside. On the contrary, in the case where 1,3-dioxolane or 1,3,5-trioxane was compounded as the cyclic acetal (Examples 1 to 10), irradiation time of 5 seconds resulted in curing completely into the inside, so that satisfactory polymerizability was shown.

TABLE 1

| | | Comparative | | | | | | | | | | |
|---|---|---|---|---|---|---|---|---|---|---|---|---|
| | | Example | Example | | | | | | | | | |
| | | 1 | 1 | 2 | 3 | 4 | 5 | 6 | 7 | 8 | 9 | 10 |
| Component (A) | 1,3-dioxolane | | 10 | 19 | 38 | 58 | 77 | | | | 10 | 19 |
| | 1,3,5-trioxane | | | | | | | 10 | 19 | 38 | 10 | 19 |
| Component (B) | Celloxide 2021P | 96 | 86 | 77 | 58 | 38 | 19 | 86 | 77 | 58 | 76 | 58 |
| Component (C) | Uvacure 1591 | 4 | 4 | 4 | 4 | 4 | 4 | 4 | 4 | 4 | 4 | 4 |

| | | | | | | | | | | | |
|---|---|---|---|---|---|---|---|---|---|---|---|
| Polymerizability | x | ∘ | ∘ | ∘ | ∘ | ∘ | ∘ | ∘ | ∘ | ∘ | ∘ |

### Examples 11 To 14

The present examples are examples in each of which 1,4-butanediol formal or diethylene glycol formal was used as the cyclic acetal. Each showed satisfactory polymerizability.

TABLE 2

| | | Example | | | |
|---|---|---|---|---|---|
| | | 11 | 12 | 13 | 14 |
| Component (A) | 1,4-butanediol formal | 19 | 38 | | |
| | Diethylene glycol formal | | | 19 | 38 |
| Component (B) | Celloxide 2021P | 77 | 58 | 77 | 58 |
| Component (C) | Uvacure 1591 | 4 | 4 | 4 | 4 |

| | | | | |
|---|---|---|---|---|
| Polymerizability | ∘ | ∘ | ∘ | ∘ |

### Examples 15 To 22

The present examples are examples in each of which a photocationic initiator and a photosensitizer were used in combination. Each showed satisfactory polymerizability.

TABLE 3

| | | Example | | | | | | | |
|---|---|---|---|---|---|---|---|---|---|
| | | 15 | 16 | 17 | 18 | 19 | 20 | 21 | 22 |
| Component (A) | 1,3-dioxolane | 10 | 20 | 39 | | | | 10 | 19 |
| | 1,3,5-trioxane | | | | 10 | 20 | 39 | 10 | 19 |
| Component (B) | Celloxide 2021P | 86 | 76 | 57 | 86 | 76 | 57 | 76 | 58 |
| Component (C) | CI-5102 | 4 | 4 | 4 | 4 | 4 | 4 | 4 | 4 |
| Photosensitizer | CS-7102 | 1 | 1 | 2 | 1 | 2 | 2 | 1 | 2 |

| | | | | | | | | |
|---|---|---|---|---|---|---|---|---|
| Polymerizability | ∘ | ∘ | ∘ | ∘ | ∘ | ∘ | ∘ | ∘ |

### Examples 23 To 35

Examples 28 to 35 are examples in each of which a polyol, an ethylenically unsaturated monomer, a radical photopolymerization initiator and a pigment were used in combination as the other components. Each showed satisfactory polymerizability.

As will be apparent from the results described above, the composition of the present invention has a high photo-curing speed and is satisfactory as a photo-curable resin composition.

TABLE 4

| | | Example | | | | | | | | | | | | |
|---|---|---|---|---|---|---|---|---|---|---|---|---|---|---|
| | | 23 | 24 | 25 | 26 | 27 | 28 | 29 | 30 | 31 | 32 | 33 | 34 | 35 |
| Component (A) | 1,3-dioxolane | 10 | | 38 | 19 | 38 | 32 | 32 | | 32 | 32 | | 10 | |
| | 1,3,5-trioxane | | 10 | | 19 | | | | 32 | | | 32 | | 10 |
| Component (B) | Celloxide 2021P | 67 | 67 | 48 | 48 | 40 | 64 | 64 | 64 | 64 | 64 | 64 | 86 | 86 |
| | 1,6-HD · DGE | 19 | 19 | 10 | 10 | 9 | | | | | | | | |
| | Epolead PB3600 | | | | | 9 | | | | | | | | |
| Component (C) | Uvacure 1591 | 4 | 4 | 4 | 4 | 4 | 4 | 4 | 4 | 4 | 4 | 4 | 4 | 4 |
| Others | PO denatured glycerin | | | | | | 10 | 20 | 10 | | | | | |
| | TMP triacrylate | | | | | | | | | 15 | 30 | 15 | | |
| | 1-OH | | | | | | | | | 1 | 2 | 1 | | |
| | Titanium oxide | | | | | | | | | | | | 50 | 50 |

| | | | | | | | | | | | | | |
|---|---|---|---|---|---|---|---|---|---|---|---|---|---|
| Polymerizability | ∘ | ∘ | ∘ | ∘ | ∘ | ∘ | ∘ | ∘ | ∘ | ∘ | ∘ | ∘ | ∘ |

Industrial Applicability

According to the present invention, the photo-curable resin composition that has a low viscosity and can be completely cured into the inside thereof in a short period of irradiation time and the cured product therefrom can be obtained.

It is expected that the novel photo-curable resin composition of the present invention finds a wide application in, for example: rapid prototyping by photochemical molding; photoresists used in the production of semiconductors such as LSI; formation of fluorescent stripes of a Braun tube; color filter pattern formation of liquid crystal displays and CCD image-taking elements; resist materials used in the formation of circuits of printed wiring board; photo-curable coating compositions; photo-curable ink; photo-curing adhesives; photo-curing sealants; photo-curable pottingagents; photo-curable coating agents; and hologram recording materials.

1. A photo-curable resin composition containing (A) a cyclic acetal compound, (B) an epoxy compound, and (C) a photocationic polymerization initiator.

2. A photo-curable resin composition containing (A) 5 to 80 wt % of a cyclic acetal compound, (B) 94.9 to 20 wt % of an epoxy compound, and (C) 0.1 to 10 wt % of a photocationic polymerization initiator (provided that total of the components (A), (B), and (C) is 100 wt %).

3. A photo-curable resin composition containing (A) 10 to 40 wt % of a cyclic acetal compound, (B) 89.8 to 60 wt % of an epoxy compound, and (C) 0.2 to 6 wt % of a photocationic polymerization initiator (provided that total of the components (A), (B), and (C) is 100 wt %).

4. A photo-curable resin composition according to any one of claims 1 to 3, wherein the cyclic acetal compound (A) is at least one kind selected from the group consisting of: trioxane; 1,3-dioxolane; 1,3-dioxane; 1,4-butanediol formal; and diethylene glycol formal.

5. A photo-curable resin composition according to any one of claims 1 to 3, wherein the epoxy compound (B) is (i) an epoxycyclohexyl group-containing compound and/or (ii) a glycidyl group-containing compound.

6. A photo-curable resin composition according to claim 5, wherein the epoxy compound (B) further contains an epoxy polymer compound having a number average molecular weight of 1,000 to 20,000 in terms of polystyrene as measured by GPC.

7. A photo-curable resin composition according to any one of claims 1 to 3, wherein the photocationic polymerization initiator (C) is an aromatic onium salt.

8. A photo-curable resin composition according to claim 7, wherein the aromatic onium salt is a triarylsulfonium salt.

9. A photo-curable resin composition according to any one of claims 1 to 3, further containing (d) a polyol having 2 or more hydroxyl groups in one molecule besides the components (A), (B), and (C).

10. A photo-curable resin composition according to claim 9, wherein the polyol (d) is a polyol having 2 to 6 hydroxyl groups in one molecule.

11. A photo-curable resin composition according to any one of claims 1 to 3, further containing an ethylenically unsaturated monomer (e) and a photo-radical polymerization initiator (f) besides the components (A), (B), and (C).

12. A photo-curable resin composition according to any one of claims 1 to 3, further containing a photosensitizer (g) besides the components (A), (B), and (C).

13. A photo-curable resin composition according to any one of claims 1 to 3, having a viscosity (25° C.) of 50 to 2,000 mPa·s.

14. A cured product obtained by photo-curing a photo-curable resin composition according to any one of claims 1 to 3.

15. A cured product obtained by photo-curing a photo-curable resin composition according to claim 4.

16. A cured product obtained by photo-curing a photo-curable resin composition according to claim 5.

17. A cured product obtained by photo-curing a photo-curable resin composition according to claim 6.

18. A cured product obtained by photo-curing a photo-curable resin composition according to claim 7.

19. A cured product obtained by photo-curing a photo-curable resin composition according to claim 8.

20. A cured product obtained by photo-curing a photo-curable resin composition according to claim 9.
